(19) United States
(12) Patent Application Publication
(10) Pub. No.: US 2008/0230958 A1
(43) Pub. Date: Sep. 25, 2008

(54) In-Mould Coating Method and Device for the Same

(76) Inventor: Yu-Syuan JIN, Taipei County (TW)

Correspondence Address: Banger Shi, 204 Cnyon Creek, Victoria, TX, 77901, US

(21) Appl. No.: 12/049,271

(22) Filed: Mar. 15, 2008

(30) Foreign Application Priority Data
Mar. 20, 2007 (TW) 096109478

(51) Int. Cl. B29C 35/08

(52) U.S. Cl. 264/447; 425/135

(57) ABSTRACT

An in-mould coating method and a coating device for the same, wherein the inserts in the mould of the coating device are made of transparent material and are each coated with reflective material. In each insert are installed light generators, light sensors, cameras, etc. The coating method comprises the steps of: closing the mould after placing a semi-finished product formed by injection molding or other processes in the mould; injecting liquid lacquer or other liquid coating material, and using the cameras to monitor filling; and after finishing filling, starting the light generators and utilizing the light sensors to monitor the amount of light irradiated on the injected liquid lacquer or other liquid coating materials in such a manner that the injected liquid lacquer or other liquid coating materials is hardened to form a coating film on the surface of the semi-finished product.

### BACKGROUND OF THE INVENTION

1. Field of the Invention

The present invention relates to an in-mould coating method and device for the same, and more particularly to an in-mould coating method and device for the same, which can form a coating film on the surface of a semi-finished product in mould by irradiating a liquid lacquer or other liquid coating materials injected into the mould.

2. Description of the Prior Art

A conventional in-mould coating method (disclosed in TW Patent Application No. 093135078) is heating liquid lacquer to harden it by use of heating wire or other heating methods to form a coating film on the surface of an injection molding semi-finished product. However, the above conventional method has the following disadvantages: it is required to additionally develop a thermosetting liquid lacquer and; it is likely to cause uneven control temperature and uneven hardening: when the heating wire or other heating methods is used, the liquid lacquer is heated to solidify via steel mould insert by heat conduction in such a manner that the coating film can be combined on the surface of the injection molding product.

The present invention has arisen to mitigate and/or obviate the afore-mentioned disadvantages.

### SUMMARY OF THE INVENTION

The primary objective of the present invention is to provide a method which can apply a liquid lacquer capable of being hardened by the light within the range from the invisible light to the visible light or a common thermosetting liquid lacquer to form a coating film on a semi-finished product formed by injection molding or other processes in mould.

The present invention injects a predetermined amount of liquid lacquer or other liquid coatings in the mould and then irradiates a predetermined amount of light to harden it, so that the semi-finished product placed in the mould can be coated with a coating film on the surface thereof.

In order to achieve the above objectives, the inserts of the mould are made of transparent material (such as quartz, glass, crystal, etc). In the transparent insert are installed at least one light generator (such as UV light, infrared ray, etc), cameras, light sensors, cooling water pipes, etc. The transparent insert is coated with a reflective layer on the outer surface thereof. A bolster is attached to the bottom of the transparent insert for fixing the cameras and the light sensors.

### BRIEF DESCRIPTION OF THE DRAWINGS

FIG. 1 is a longitudinal cross-sectional view of: a mould in accordance with the present invention; and

FIG. 2 is a longitudinal cross-sectional view of another in-mould coating device in accordance with the present invention

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

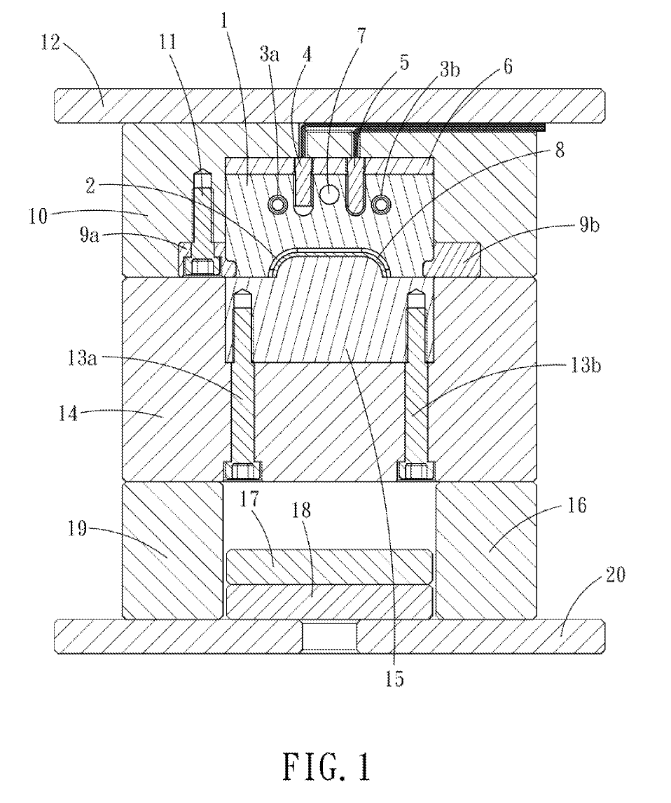

Referring to FIG. 1 a mould in accordance with a preferred embodiment of the present invention comprises: a fixed plate 10, a moving plate 14, a fixed insert 1, a moving insert 15, insert-fixing plates 9a, 9b, a fixed retainer 12, a moving retainer 20, spacer blocks 16, 19, an upper ejector plate 17, and an lower ejector plate 18. The fixed insert 1 is also fixed in the cavity of the fixed plate 10 by a plurality of screws 11 in the same way of the conventional one, but the difference is that, a bolster 6 should be attached to the bottom of the fixed plate 10 in advance, and then the fixed plate 10 is fixed. The moving insert 15 is directly locked on the moving plate 14 by a plurality of screws 13a, 13b. Additionally, the fixed insert 1 of the present invention is made of transparent material (such as quartz, glass, crystal, etc) and then coated with a reflective layer on the outer surface thereof. After that, more than one light generator is assembled inside the fixed insert 1 according to the requirements of the mould design. At the same moment, after being further fixed in advance with more than one camera 4 and more than one light sensor 5, the above bolster 6 is inserted in the transparent fixed insert 1, and the plurality of screws 11 is then used to lock the fixed insert 1 to the fixed plate 10. After the transparent fixed insert 1 is locked, its inner equipments, such as the light generators 3a, 3b, the cameras 4 and the light sensors 5, will be equipped with the on-off and control wires, finishing the assembly of the in-mould coating device of the present invention.

To summarize, when the mould of the present invention performs the coating on the surface of an injection molding semi-finished product 8 to form a coating film, the injection molding semi-finished product 8 is placed on the moving insert 15 of the mould first (as shown in FIG. 1). Subsequently, the mould will be closed, the liquid lacquer or other liquid coating materials will be injected into the clearance between the transparent fixed insert 1 and the injection molding semi-finished product 8, and the camera 4 will be used to monitor the filling state. After the injection is finished, the light generators 3a, 3b will be started, and the light sensor 5 will be used to monitor the amount of light irradiated on the injected liquid lacquer or other liquid coating materials. After the complete hardening of the liquid lacquer, a coating film 2 can be formed on the outside surface of the injection molding semi-finished product, achieving the desired appearance and function of the finished product.

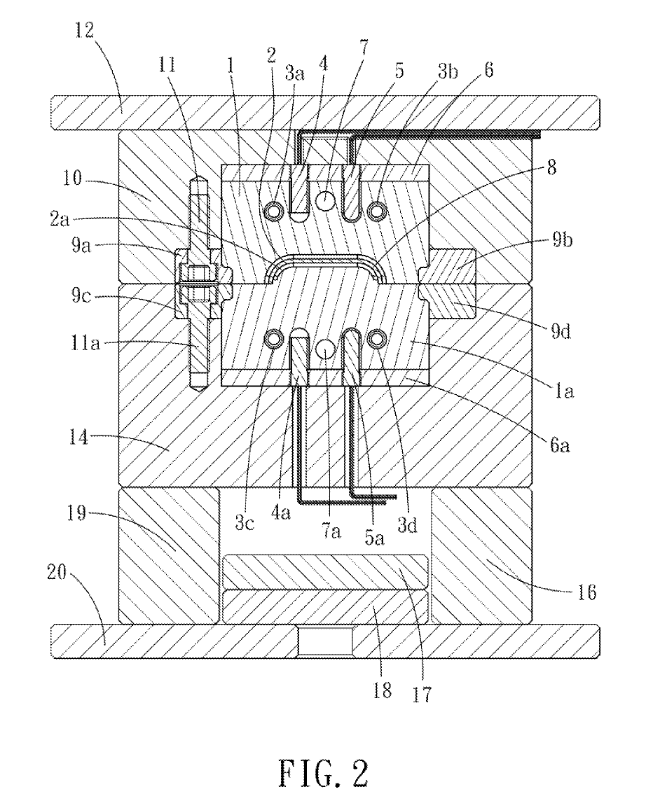

Further, FIG. 2 shows an in-mould coating device in accordance with another embodiment of the present invention. The in-mould coating device of the present invention is assembled on a moving insert 1a of an injection mould, and the moving insert 1a is made of transparent material as described above and coated with a reflective layer on the outer surface thereof. After that, a predetermined number of light generators 3c, 3d, cameras 4a and light sensors 5a are installed in the transparent moving insert 1a, and then the on-off and control wires will be equipped (not shown). Finally, the bolster 6a fixed with the cameras 4a and the light sensors 5a is attached to the bottom of the moving insert 1a, and the insert-fixing plates 9c, 9d are then used to lock the moving insert 1a in the cavity of the moving plate 14 by a plurality of screws 11a, finishing the assembly of the in-mould coating device of the present invention. Thereby, by applying the above method, an injection molding semi-finished product 8 is placed on the moving insert 1a, and the liquid lacquer or other liquid coating materials is injected into the clearance therebetween for coating the “inside surface” of the injection molding semi-finished product 8 with a coating film 2a. For the same reason, the in-mould coating device of the present invention can also be as shown in FIG. 2 completely, and the device is on both the fixed insert 1 and the moving insert 1a. By such arrangements, the above method can be used to form a coating film 2, 2a on each of the “inside” and the “outside” surfaces of an injection molding semi-finished product 8 synchronously.

Additionally, an injection molding semi-finished product 8 is placed on the transparent fixed insert 1 or moving insert 1a of the mould of the present invention by the following two ways. 1. Forming a semi-finished product 8 by injection molding or other processes (such as extrusion molding process, or vacuum forming process, etc), then placing the semi-finished product 8 on the transparent fixed or moving inserts 1, 1a of the present invention; 2. By way of double injection moulds, fixing both the injection mould of semi-finished product and the mould of the present invention on an injection molding machine capable of rotating or moving; next, forming an injection semi-finished product 8 first by the injection mould of semi-finished product, and then placing the injection semi-finished product 8 on the transparent fixed or moving inserts 1, 1a of the injection mould of the present invention after mould opening; and finally, closing mould again. In addition, the representative symbols 7, 7a as shown in FIGS. 1-2 are the cooling water pipes of the injection moulds in accordance with two embodiments of the present invention, respectively.

In addition, the in-mould coating device of the present invention can also be obtained by the methods as follows:

1. More than one light generator 3a, 3b, 3c, or 3d on the in-mould coating device of the present invention can also be on other mould parts besides the transparent fixed or moving inserts 1 or 1a.

2. The in-mould coating device of the present invention can be provided with a predetermined number of concaves or protrusions in a predetermined shape at the outer surface of the finished product of the fixed or moving inserts 1 or 1a for adequately reflecting the light from the light generators 3a, 3b or 3c to the surface of the semi-finished product 8.

3. If the injection molding semi-finished product 8 has hooks or a complicated shape or configuration, the fixed or moving inserts 1 or 1a of the in-mould coating device of the present invention can be provided with other demoulding mechanisms (not shown), which can also be made of transparent material such as quartz, glass, crystal (if necessary).

While we have shown and described various embodiments in accordance with the present invention, it is clear to those skilled in the art that further embodiments may be made without departing from the scope of the present invention.

What is claimed is:

1. An in-mould coating device being a coating device disposed in a mould, the mould consisting of a fixed plate, a moving plate, a fixed insert, a moving insert, insert-fixing plates, a fixed retainer, a moving retainer, spacer blocks, an upper and a lower ejector plates; the in-mould coating device is characterized in that:
the fixed insert is made of transparent material selected from the group consisting of quartz, glass, crystal first and is then coated with a reflective layer on an outer surface thereof;
more than one light generator, more than one camera and more than one light sensor are inserted in the transparent fixed insert and equipped with on-off and control wires; and
a bolster is attached to a bottom the transparent fixed insert for fixing the fixed insert and the cameras and light sensors.

2. An in-mould coating method comprising the steps of:
placing a semi-finished product formed by injection molding or other processes on the moving insert of the mould;
injecting a liquid lacquer or other liquid coatings into a clearance between the transparent fixed insert and the injection molding semi-finished product after mould closing;
utilizing the cameras to monitor filling state; and
after finishing filling, starting the light generators and using the light sensors to monitor the amount of light irradiated on the liquid lacquer or other liquid coating materials, causing a chemical hardening to form a coating film on a surface of the injection molding semi-finished product, thus obtaining a desired finished product.

3. The in-mould coating device as claimed in claim 1, wherein the moving insert of the in-mould coating device is made of transparent material selected from the group consisting of quartz, glass, crystal.

4. The in-mould coating device as claimed in claim 1, wherein the transparent fixed insert of the in-mould coating device is formed with a predetermined number of concaves in a predetermined shape in an outer surface and is then coated with a reflective layer for adequately reflecting the light from the light generators to the surface of the semi-finished product.

5. The in-mould coating device as claimed in claim 1, wherein the transparent fixed insert of the in-mould coating device is formed with a predetermined number of protrusions in a predetermined shape on an outer surface and is then coated with a reflective layer for adequately reflecting the light from the light generators to the surface of the semi-finished product.

6. The in-mould coating device as claimed in claim 1, wherein the transparent moving insert of the in-mould coating device is formed with a predetermined number of concaves in a predetermined shape in an outer surface thereof and is then coated with a reflective layer for adequately reflecting the light from the light generators to the surface of the semi-finished product.

7. The in-mould coating device as claimed in claim 1, wherein the transparent moving insert of the in-mould coating device is formed with a predetermined number of protrusions in a predetermined shape on an outer surface thereof and is then coated with a reflective layer for adequately reflecting the light from the light generators to the surface of the semi-finished product.

8. The in-mould coating device as claimed in claim 3, wherein the transparent fixed insert of the in-mould coating device is formed with a predetermined number of concaves in a predetermined shape on in an outer surface and is then coated with a reflective layer for adequately reflecting the light from the light generators to the surface of the semi-finished product.

9. The in-mould coating device as claimed in claim 3, wherein the transparent fixed insert of the in-mould coating device is formed with a predetermined number of protrusions in a predetermined shape on an outer surface and is then coated with a reflective layer for adequately reflecting the light from the light generators to the surface of the semi-finished product.

10. The in-mould coating device as claimed in claim 3, wherein the transparent moving insert of the in-mould coating device is formed with a predetermined number of concaves in a predetermined shape in an outer surface and is then coated with a reflective layer for adequately reflecting the light from the light generators to the surface of the semi-finished product.

11. The in-mould coating device as claimed in claim 3, wherein the transparent moving insert of the in-mould coating device is formed with a predetermined number of protrusions in a predetermined shape on an outer surface and is then coated with a reflective layer for adequately reflecting the light from the light generators to the surface of the semi-finished product.

12. The in-mould coating device as claimed in claim 1, wherein the more than one light generator of the in-mould coating device is disposed on other parts, besides the transparent fixed and moving inserts.

13. The in-mould coating device as claimed in claim 3, wherein the more than one light generator of the in-mould coating device is disposed on other parts, besides the transparent fixed and moving inserts.

14. The in-mould coating device as claimed in claim 1, wherein the fixed and moving inserts of the mould are both made of transparent material selected from the group consisting of quartz, glass, crystal.
